(19) United States
(12) Patent Application Publication
(10) Pub. No.: US 2007/0127523 A1
(43) Pub. Date: Jun. 7, 2007

(54) Enhanced display systems with DVC connectivity

(76) Inventor: Neil Marrow, San Jose, CA (US)

Correspondence Address: WAGNER, MURABITO & HAO LLP, Third Floor, Two North Market Street, San Jose, CA, 95113, US

(21) Appl. No.: 11/595,352

(22) Filed: Nov. 9, 2006

Related U.S. Application Data
(60) Provisional application No. 60/748,649, filed on Dec. 7, 2005.

(51) Int. Cl. H04J 3/22

(52) U.S. Cl. 370/468

(57) ABSTRACT

A display connectivity controller that is coupled externally to a display system is disclosed. The display connectivity controller includes a device detector for detecting the connectivity status of a digital video cassette (DVC) content source and the acquiring capabilities data of the DVC content source, a play control device for controlling playback modes of the digital video cassette content source and a host bus interface for communicating with the display system. The display connectivity controller additionally includes a host bus interface logic set for receiving commands from a processor of the display system through the host bus interface and for communicating with the device detector and the play control device according to the commands.

### RELATED U.S. APPLICATIONS

This application claims priority to co-pending provisional application Ser. No. 60/748,649, filed on Dec. 7, 2005, which is hereby incorporated by reference to this specification.

### FIELD OF THE INVENTION

The invention relates to display system, more specifically, to display systems that provide at least one external interface port for the connectivity and playback of digital video cassette recorder/player equipment.

### BACKGROUND OF THE INVENTION

Many conventional consumer electronic camcorders, that use mini-DV cassettes as the recording medium, feature an IEEE1394 serial bus port connection. Conventionally, a digital video cassette (DVC) recorder/player may be equipped with an IEEE1394 High Performance Serial Bus interface port, that is used to transfer coded data. For example, a camcorder may use the IEEE1394 interface to send DVC data to a display system, such as may be associated with a personal computer or to an enhanced display system that is equipped with an IEEE1394 port for the purpose of DVC playback.

The IEEE1394 serial bus protocols, as specified by the IEEE1394-1995 and later versions such as IEEE1394a-2000, are specified as a set of stacked layers: physical layer, link layer, and transaction layer. The physical layer defines the mechanical interface, such as port plug dimensions. Additionally, the physical layer includes an arbitration algorithm to guarantee only one node is sending data at a time, and also includes circuitry to translate the logical symbols used by the link layer into electrical signals on the IEEE1394 bus. The link layer provides addressing logics, data framing and data integrity check logics, and some timing logic services to support a unique feature of IEEE1394 called “isochronous data transfers” that enable real-time applications to acquire a pre-determined quantity of bus bandwidth and use it on a periodic 125 us cycle. The transaction layer defines a protocol to perform the bus transactions required to support the underlying control and status register architecture specified by IEEE1394 and IEEE1212, in addition to general read and write transactions that are specific to a particular IEEE1394 node application; for example, to write an element of an electronic file to a 1394 hard disk drive.

Camcorders equipped with mini-DV cassettes generally comply with the audio and video coding techniques specified by ISO/IEC 61834 or SMPTE 306M. These coding specifications, among other details, discuss the audio sampling rates, encoding rules for audio data, audio mixing techniques, and data formatting rules that apply to audio data written to the digital video cassette (DVC). Furthermore, these specifications include similar rules pertaining to video, including the video compression algorithm based on a discrete cosine transform, or DCT, technique commonly applied to video data. Data formatting of the luminance and color data, variable length encoding, and video data structure formatting as video data is written to the DVC tape and are specified.

Conventional mini-DV camcorders may also be generally equipped with composite video and analog audio outputs to provide a convenient method of playback to a conventional television system. This conventional method often uses a proprietary cable, and does not benefit from the application of industry standard IEEE1394 cable options. Furthermore, the video and audio can be compromised by a set of digital-to-analog and analog-to-digital conversions on the data.

Televisions supporting 1394 connection can be found in the market, such as in some related MITSUBISHI products. A high-end processor, such as a 32-bit RISC microprocessor is required in such TV system in order to support 1394 connection. The signal processing architecture in such TV systems does not include 1394 transaction layer logic. The 1394 transaction logic as well as the audio/video decoding algorithm is run on software on the high-end processor in the TV, as part of a so called “centralized architecture”. This highly integrated software solution can be costly due to the use of the high-end processor.

However, most TV systems are equipped with a relatively low-end processor. Usually, these low-end processors may not have the capacity to support 1394 transaction layer logic in hardware design. Moreover, display manufacturers might not be willing to upgrade the existing TV processor just for enabling 1394 connection because a high-end processor entails a complex processing system which correspondingly entails cost increases.

Some DVC camcorders have been introduced to the market with a USB bus interface, replacing the IEEE1394 port. The USB bus is a more popular interface to personal computers and peripherals, such as disk drives, which may contain JPEG pictures or other audio/video digital content; thus, offering a cost benefit by economy of scale. Many conventional display systems lack a convenient interface port, or ports, for USB peripheral connectivity that can be used for delivering audio/video digital content from a USB device, such as a storage device or DVC playback device with a USB bus interface, to the display system for further image and sound processing.

### SUMMARY OF THE INVENTION

A display connectivity controller that is coupled externally to a display system is disclosed. The display connectivity controller includes a device detector for detecting the connectivity status of a digital video cassette (DVC) content source and the acquiring capabilities data of the DVC content source, a play control device for controlling playback modes of the digital video cassette content source and a host bus interface for communicating with the display system. The display connectivity controller additionally includes a host bus interface logic set for receiving commands from a processor of the display system through the host bus interface and for communicating with the device detector and the play control device according to the commands.

In one embodiment, a display connectivity controller is provided for bringing DVC playback and other content to a display system. The connectivity controller is enhanced with 1394 transaction logic and a DVC decoder, offering a distributed DVC playback architecture utilizing little workload of the display system programmable CPU and digital signal processor DSP. The invented display connectivity controller includes a host of options such as detection of a DVC content source, and generation of on-screen display OSD icons based on 1394 device connection state or playback mode.

In one embodiment, the display connectivity controller is fully capable of streaming post-processed audio and video data to the display system by auxiliary audio and auxiliary video interfaces. These auxiliary interfaces can be shared with other conventional connectivity circuits such as JPEG decoders for digital camera removable media.

Furthermore, at least one embodiment offers a centralized architecture for DVC processing where DVC content is acquired by the display connectivity controller and passed to a display system programmable CPU, or digital signal processor, for further processing. In one embodiment of the display system implementing centralized DVC processing, a USB2.0 interface connects core system components to the display connectivity controller. Additionally, the connectivity controller is equipped with a data channel to deliver DVC data acquired from a 1394 device to a USB host interface on the display system. Alternately, the display connectivity controller is further equipped to receive DVC data from a USB host interface for decode.

Several system architectures are considered and illustrated that incorporate embodiments of the connectivity controller.

### BRIEF DESCRIPTION OF THE DRAWINGS

Features and advantages of embodiments of the invention will become apparent as the following Detailed Description proceeds, and upon reference to the Drawings, where like numerals depict like elements, and in which:

FIG. 1 illustrates a display system having a connectivity controller as a part of a display system operating environment according to one embodiment of the present invention.

FIG. 2 illustrates a block diagram of a display connectivity controller according to the present invention.

FIG. 3 illustrates a first enhanced display system implementing the display connectivity controller according to one embodiment of the present invention.

FIG. 4 illustrates a second enhanced display system implementing the display connectivity controller according to one embodiment of the present invention.

FIG. 5 illustrates a third enhanced display system implementing the display connectivity controller according to one embodiment of the present invention.

### DETAILED DESCRIPTION OF THE INVENTION

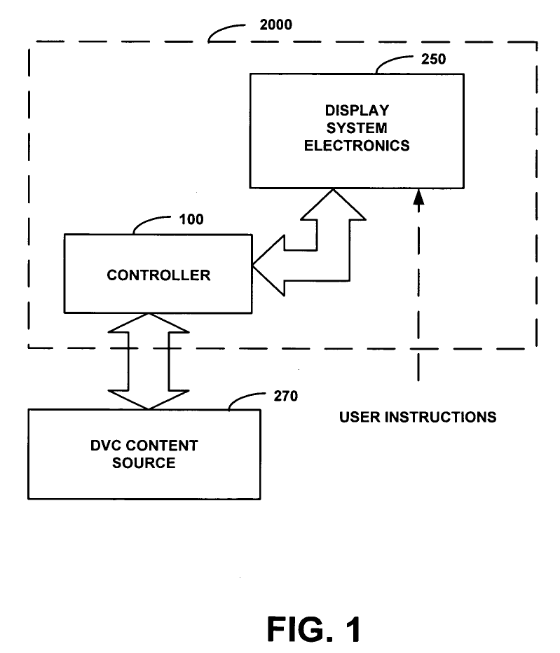

FIG. 1 shows a display system 2000 having a connectivity controller as a part of a display system operating environment according to one embodiment of the present invention. FIG. 1 shows a connectivity controller 100, a display system electronics 250 and a content source 270.

Referring to FIG. 1, connectivity controller 100 is a discrete component that is coupled externally to the internal display system circuitry 250. In one embodiment, connectivity controller 100, operates to determine whether a DVC content source 270 is connected (connectivity status), what the content source capability is and to control content source 270 playback modes. In one embodiment, information can be obtained by connectivity controller via display system electronics (e.g., CPU, data storage units, bus system etc.) that support the operation of connectivity controller 100. In one embodiment, such information can include but is not limited to commands from a CPU that support the determination of connectivity status, the ascertainment of content source capability and the control of content source playback modes.

In one embodiment, the connectivity controller 100 may include a 1394 port, 1394 transaction layer logic and a DVC decoder. The display system electronics 250 may be a TV system with a conventional system CPU. In one embodiment, the DVC content source 270 may be a DVC camcorder with support for 1394 specification. In operation, the system CPU may receive instructions from a user input panel coupled to the TV system or a remote controller. Such instructions may include detecting the presence of the 1394 content source and the controlling the playback mode of the content source, etc. The connectivity controller 100 may communicate with the system CPU and execute the instructions to control the DVC content source, for example, determine the capability of the DVC content source 270, determine if DVC content can be received and determine the playback mode of the DVC content source, such as play, stop, forward or backward, etc. Such control instructions may cause data exchanges with the DVC content source by means of the 1394 transaction layer logic included in the connectivity controller 100. The connectivity controller 100 may further capable of decoding the encoded audio and/or video data acquired from the DVC content source and outputting the decoded audio and/or video data to the TV system for DVC content playback over an auxiliary audio interface and an auxiliary video interface comprised in the connectivity controller 100.

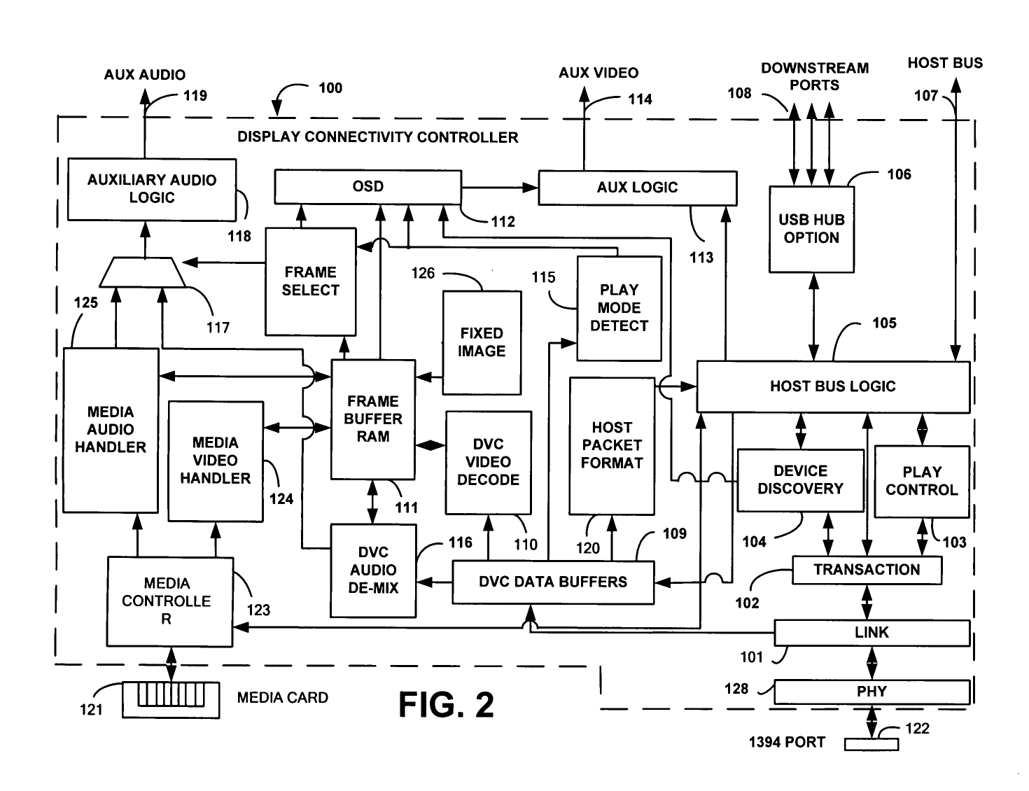

FIG. 2 is a block diagram of at least one implementation of the display connectivity controller (100) discussed in FIG. 1. The controller generally interfaces to components on a display system (e.g. a TV system) through a host bus interface (107), an auxiliary video interface (114), and an auxiliary audio interface (119). FIG. 2 depicts user connectivity to a 1394 port (122), a media card (121) slot, and optionally USB ports (108).

A Philips 12C compatible host bus interface (107) may be used for the enhanced display system implementing distributed DVC processing, that is, the DVC decoding process is performed by the display connectivity controller rather than the processor in the display system. In this embodiment, the 12C interface (107) is used to pass high level control data to the display connectivity controller (100); for example, a command to disable the auxiliary video output (114), placing it in a high-impedance state. The 12C interface (107) as used in display systems described herein, requires a simple set of host bus logic (105) to implement, and has wide industry support.

Alternately, a Universal Asynchronous Receiver and Transmitter, UART, interface can be used, such as that referred to as RS232, or Serial Port protocol, for the host bus interface (107). Micro-processors used for herein described display systems can employ the UART protocols and interface. Similar to 12C, the UART interface requires a set of host bus logic (105) to support.

For enhanced display system implementing centralized DVC processing, that is, the DVC decoding process is performed by a high-end programmable CPU, such as a conventional RISC processor, or digital signal processor DSP, in the display system, a choice of Universal Serial Bus, or USB, may be preferred for the host bus interface (107). In such a centralized DVC processing system, a USB2.0 interface may be appropriate to accept DVC data at a high speed from the connectivity controller (100) for processing. Conventional RISC processors commonly include support for USB, as it can support higher throughput than UART and I2C protocols, and has wide industry acceptance—especially in computer connectivity applications. A hybrid system is also contemplated that uses I2C as a high-level control interface, and pushes DVC data to the connectivity controller (100) for processing using a USB2.0 host bus (107), such that the DVC coded data is packaged by the system core programmable CPU or DSP, delivered to the connectivity controller using the host bus interface (107), and then decoded by the connectivity controller (100) and output to auxiliary audio (119) and auxiliary video (114) outputs. Host bus logic (105) to support USB may be more detailed as compared to I2C and UART logics. In the case of USB2.0, the physical layer is highly detailed for 400+ Mbps data exchange. The physical layer is not shown in FIG. 2, but generally considered an integral part of host bus logic (105).

For applications of the connectivity controller (100) that utilize the controller's integrated video decoders, an auxiliary video interface (114) may be provided to pass the decoded video data to the display system. One embodiment implements the ITU-R.BT656 (114) interface for auxiliary video, and provides a method to disable the outputs, placing them in a high-impedance state. Aux interface logic (113) may be required to conform to the BT656 interface specifications for timing and control. Similarly, an ITU-R.BT601 (114) protocol may also be used, as BT656 and BT601 logic (113) are similar. Alternate embodiments consider adding DAC circuitry, such that the aux video (114) output is a composite video channel, a component video interface, or another method to deliver video to the display system's video processing sub-system; whereas the DAC circuits are generally considered an integral part of the aux logic (113).

For applications of the connectivity controller (100) that utilize the controller's integrated audio decoders, and/or audio de-mixers, an auxiliary audio interface (119) may be provided to pass the audio data to the display system. One embodiment implements the PHILIPS TM I2S (119) interface for auxiliary audio. A logic (118) to implement I2S can be generally small, and I2S as a CODEC interface has wide industry adoption. Alternate embodiments add CODEC circuitry such that the aux audio (119) output is an analog output for delivery of audio to the display system's audio processing sub-system; whereas the CODEC circuits are generally considered an integral part of the aux audio logic (118).

In one embodiment, the connectivity controller (100) implements a signal interface for communicating with IEEE1394, or 1394, devices connected to a 1394 port (122) on the display system. The 1394 port (122) may be a 4-pin or 6-pin IEEE1394a-2000 type connector, and may additionally support connection methods defined for 1394b. In one embodiment, the connectivity controller (100) includes the 1394a-2000 cable physical layer circuits (128) to limit the component count on the display system, reducing materials costs and board space. The physical layer (128) includes an arbitration algorithm to assure that only one node at a time sends data, and also includes circuitry to translate between the logical symbols used by a 1394 link layer (101) into electrical signals on the IEEE1394 port (122) bus.

One embodiment includes support for media card (121) connectivity, such that the display system includes a slot for insertion and removal of the removable card (121) media, and support for Secure Digital SD Memory. Other popular types of media cards (121) can be supported through multi-slot connectors that support more than one type of media, or by a group of several individual connectors. Support for xD-Picture Card, Memory Stick, MultiMediaCard, Mini-SD, CompactFlash, and ExpressCard are contemplated.

A media controller block (123) may be included to support the protocol(s) necessary to interface to the media card (121). The media controller (123) includes additional logic to parse the FAT file system structures residing on the media card (121), fetch audio/video files from the media card (121), deliver audio file data to a media audio handler (125), and deliver video file data to a media video handler (124). It is contemplated that a set of complex media controller tasks may be performed under control of a system CPU or DSP, utilizing a data channel from the host bus logic (105) to the media controller (123), for example, such data channel may allow the system CPU to read data locations on the media card (121). In the case of audio, the media audio handler (125) may include digital signal processing algorithms to decode conventional coded audio formats such as MP3 and AAC. In the case of video, the media video handler (124) includes digital signal processing algorithms to decode conventional coded video formats such as JPEG, M-JPEG, and MPEG versions.

The media audio handler (125) may use the frame buffer RAM (111) as intermediate workspace as it decodes the audio, which is then delivered to a mux circuit (117) which can select the media audio handler (125) output data to deliver to the auxiliary audio logic (118) for playback over the auxiliary audio interface (119). The media video handler (124) may also use the frame buffer RAM (111) as intermediate workspace as it decodes the video, and then finally uses it to store the decoded video image frame(s). In the case of a unified audio/video file such as MPEG, the frame buffer RAM may be used to transfer data between the media audio handler (125) and media video handler (124), whereas generally the MPEG file is delivered to the media video handler (124) which parses the audio component and delivers to the media audio handler (125) via the frame buffer RAM (111).

For embodiments that include USB support, the display system may optionally offer a user connection to USB through a USB port. One embodiment of the connectivity controller (100) may include a USB hub (106) to provide multiple downstream ports (108) for user connectivity when the host bus (107) is USB. It is contemplated that the USB hub (106) may be optional for the connectivity controller (100), as many display systems do not include USB support. Generally, a USB hub (106) supporting USB2.0 protocols can include transaction translation to map USB1.1 protocols operating on a first downstream port to the USB2.0 host bus (107) without slowing a device connected to a second downstream port operating at USB2.0 high-speed data rate.

In one embodiment, the connectivity controller (100) may implement 1394 link layer logic (101). The link layer (101) provides addressing logics, data framing and data integrity check logics, and some timing logic services to support a unique feature of IEEE1394 called “isochronous data transfers” that enable real-time applications to acquire a pre-determined quantity of bus bandwidth and use it on a periodic 125 us cycle. The link layer (101) of the connectivity controller offers an access method to acquire physical layer events, such as cable insertion and removals from the 1394 port (122), to higher layers, that is the device discovery block (104) and transaction layer block (102); thus, the link layer (101) provides a unified path between the physical layer (128) and the remainder of the controller (100).

An additional connection between the device discovery block (104) and the link layer (101) provides a method for a device connected to the 1394 port (122) to read a 1394 configuration ROM of the display connectivity controller (100), whereas the configuration ROM may report capabilities of 1394 devices and can be used for general underlying control and status per the register architecture specified by IEEE1394 and IEEE1212.

In one embodiment, the connectivity controller (100) implements 1394 transaction layer logic (102). The 1394 transaction layer defines a protocol to perform the bus transactions required to support 1394 configuration ROM access, in addition to general read and write transactions that are specific to a particular IEEE1394 node application; for example, to write an element of an electronic file to a 1394 hard disk drive, or how to control the playback mode of a 1394 camcorder. There exists a control path for host bus logic (105) access to the transaction layer, providing a high-level interface for requests from a host bus (107) controller. The host bus logic (105) data exchange with the transaction layer (102) include addresses, data, and command-specific information but may not have the format consistent to interface to the 1394 link layer (101), as this formatting and bus transaction handling, such as handling split-transactions, is performed by the transaction layer logic (102).

An interface is defined for transaction layer (102) services to playback mode control logic (103), whereas playback mode control logic (103) is equipped to operate 1394 asynchronous transactions used to control the playback mode of a 1394 camcorder or similar DVC player device. Generally, the playback mode control logic (103) may include functions specified by the AV/C Tape Recorder/Player Subunit Specification published by the 1394 Trade Association. This specification intends to make an industry standard for control of audio/video tape recorders and players, such as the mini-DV camcorders discussed here. The playback mode control logic (103) may be controlled by commands from the system host bus interface (107, 105); for example, high level commands such as STOP, PLAY, REVERSE, FASTFORWARD, can be processed. It is contemplated that such commands are determined by a programmable CPU or DSP on the display system with connectivity to conventional display human interface devices such as push buttons and infrared IR receivers for functioning with remote controls, whereas this human interface device input may be translated to a command structure that is understood by the display connectivity controller (100) host bus logic (105) and playback mode control logic (103).

An interface is defined for transaction layer (102) services to device discovery logic (104), whereas device discovery logic (104) is equipped to operate 1394 asynchronous transactions used to read the 1394 configuration ROM of a connected 1394 device and identify it as DVC player device, and determine if the device is generally controlled by the AV/C Tape Recorder/Player Subunit Specification, based on the values of 1394 configuration ROM. The device discovery logic (104) may communicate information obtained by 1394 asynchronous transactions to the host bus logic (105), whereas device specific data may be displayed to the user through the graphical user interface of a content distribution application operating on the system's programmable CPU, or digital signal processor DSP. Additionally, initial state and information obtained by the device discovery logic (104), that is the connection state, can be communicated to the on-screen-display OSD logic (112), whereas a textual or iconic image is overlaid upon image data obtained from the frame buffer RAM (111) based on the connection state.

The link layer (101) of the connectivity controller offers an interface to the DVC data buffers block (109), whereas the interface passes isochronous data obtained form a 1394 isochronous channel, a point-to-point isochronous data stream or a broadcast isochronous channel are considered. The data delivered to the DVC data buffers (109) is generally of the format specified by the ISO/IEC 61883 International Standard that specifies the digital interface for consumer audio/video equipment using 1394, describing the general packet format, data flow management, connection management, and general transmission rules for control commands. It is contemplated that the plug control registers specified in ISO/IEC 61883 are an integral part of the play control logic (103), as well as other details relating to setup and tear-down of the isochronous data communication channel between the payback device and a receiver of the isochronous data.

The DVC data buffers (109) extract information from the common isochronous packet CIP headers defined in ISO/IEC 61883 from the general DIF blocks of DVC data before delivery to the DVC video decode. Such information may include the DVC format type, that is, compliance to ISO/IEC 61834 or SMPTE 306M or another DVC compression standard, and video source details such as number of lines per frame. The DVC data buffers (109) may use a FIFO (First In First Out) scheme to buffer the DVC data to accommodate processing latency such as that which may occur by access to a shared resource, such as the frame buffer RAM (111), whereas the FIFO scheme accommodates DVC data acquired from two or more isochronous periods.

The delivery of DVC data to the DVC data buffers (109), and/or details of the DVC data, are used determine at least one element of the playback mode by the playback mode detect circuit (115), whereas this detect circuit (115) comprises an interface to the DVC data buffers (109). The playback mode detect circuit (115) may provide detection information to the frame select (127) block and the OSD block (112). The frame select block (127) may use the detection information to determine to output a fixed image (126), an image generated by the DVC video decoder (110), or an image obtained from another video handler, such as a media video handler (124) that is source video from a media card (121). The fixed image generator (126) may provide a solid color screen image, such as a popular blue screen, or any pre-determined fixed image, such as that representing the logo of the system, or video sub-system, manufacturer. In addition to control by the play mode detect circuit (115), the frame select circuit (127) may be controlled by commands from the host bus (107) protocol; although this is not illustrated in FIG. 2.

The play mode detect logic (115) interface to the OSD block (112) provides at least one element of information relating to the playback mode; for example, if the isochronous data reception is accepted, or data obtained has errors, or the audio MUTE may be selected. However, the OSD block may also be provided playback mode information from the play control block (103), to indicate at least one specific state of the playback channel, such as that the image is played at REVERSE mode; although the connection between the OSD block (112) and the play control block (103) is not shown in FIG. 2. The on-screen-display OSD logic (112) may be used to overlay a textual or iconic image upon image data obtained from the frame buffer RAM (111) based on the connection state and/or playback mode, before delivery of the final image to the auxiliary video logic (113) to output to the auxiliary video interface (113).

In the case of a USB host interface, the host packet formatter block (120) may create USB packet structures based on the data stored in the DVC data buffers (109) for delivery to an external central processing unit through an interface with the host USB bus (107), operating USB protocols as controlled by the host bus logic (105). Generally, the system configuration that complements the utility of the host packet formatter block (120) has relatively high-end programmable CPU or DSP operating instructions to decode the DVC data. Similarly, a data path exists for a system CPU or DSP to push DVC data to the DVC data buffers (109) through the host bus logic (105), preferably a high-speed interface such as USB. It is contemplated that a display system CPU or DSP acquired DVC data from a content source other than the display connectivity controller's 1394 port (122), and utilizes the DVC video decoder (110) features in the connectivity controller by passing data from the USB host bus (107) directly to the DVC data buffers (109) for processing.

The DVC data buffers (109) can deliver DVC digital information data structures to the DVC audio de-mix logic (116) to generate audio to a mux circuit (117) which can select the DVC audio de-mix (116) output data to deliver to the auxiliary audio logic (118) for playback over the auxiliary audio interface (119), whereas the mux circuit (117) may be controlled by a method consistent with that controlling the frame select block (127), that may be obtained from a host bus logic (105) communication. For example, an isochronous channel may be open and DVC playback mode detected as PLAY from the play mode detect circuit (115); however, a system CPU or DSP may select to view a JPEG file from a media card (121) through a communication with the host bus logic (105).

The audio data structures contain DVC digital information blocks, called DIF blocks, that are stored and arranged in the frame buffer RAM (111) under the control of the DVC audio de-mix block (116). The basic de-mixing algorithms are consistent with the audio mixing specified by ISO/IEC 61834 or SMPTE 306M. The audio de-mix block (116) may further comprise logic to ensure that the audio and video playback over the aux audio (119) interface and aux video (114) interface are synchronized, whereas method to ensure the synchronization involves controlling the skipping of at least one video frame if the audio runs ahead of the video and controlling the replay of at least one video frame if the audio runs behind the video. Furthermore, the audio de-mix block (116) may be equipped to handle at least one missing DIF block, as the DIF blocks may be sequenced as specified by ISO/IEC 61834 or SMPTE 306M, whereas the missing DIF block may be replaced with pre-determined zero data.

The DVC data buffers (109) can deliver DVC digital information data structures to the DVC video decoder (110) to generate a video image, whereas frames of video are stored in the frame buffer RAM. The basic video decode algorithms are consistent with the encoding specified by ISO/IEC 61834 or SMPTE 306M, for example, the video decoder contains inverse variable length encoding algorithms and inverse DCT transform algorithms. The DVC video decoder (110) supports the various line sizes and chroma/luma sampling rates specified by ISO/IEC 61834 or SMPTE 306M, and includes a frame formatter, or framer, logic (not shown) that is consistent with the addressing scheme for 4:2:2 sampling utilized by the BT656 standard.

It should be noted that the display connectivity controller (100) illustrated in FIG. 2 is a combination of a plurality of exemplary embodiments. The features and functionalities presented in this display connectivity controller (100) might be selectively implemented depending on different types of display systems, applications, manufacturing considerations and/or customer requirements. For example, in a display system having a relatively high-end DSP or CPU that is able to handle more connectivity devices than 1394 device, e.g. USB or internet wireless connection, the DVC video decoder (110) and DVC audio De-Mix block (116) in FIG. 2 may not be needed. The connectivity controller (100) may just buffer 1394 data and pass the data over to the display system through USB interface, whereas the video and audio decoding are done in the high-end system DSP or the CPU. Therefore, in operation, the decoder modules ((110), (116)) and host packet format block (120) may operate exclusively, or may not coexist in a same chip.

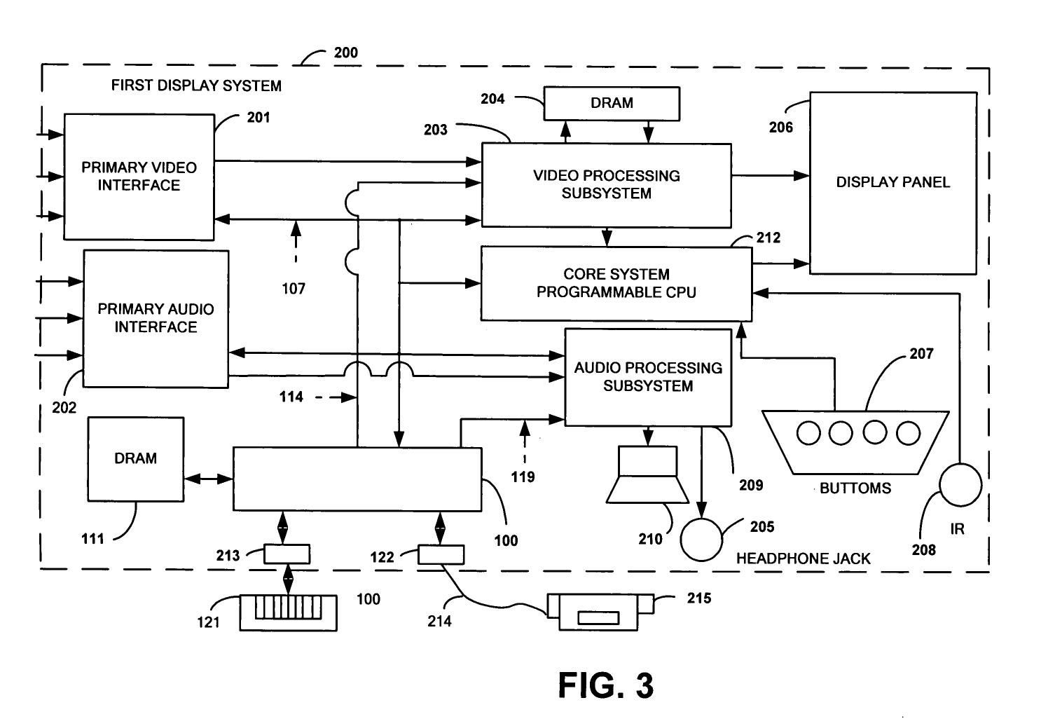

FIG. 3 illustrates a first enhanced display system (200) with associated display connectivity controller according to one embodiment of the present invention. The system comprises conventional primary video inputs interface (201) for receiving analog or digital video from a transmitting source, such video inputs may include, but are not limited to, a VGA compatible signal, a composite video signal such as NTSC or PAL, component video, a digital video interface DVI input, encoded digital video such as DVI-HDCP, and other video sources. Generally the primary video inputs (201) circuitry contains analog-to-digital A2D conversion, video decoding, and filtering to convert to a primary digital interface connection to a core video processing subsystem (203) such interface may be compatible with BT656.

In the FIG. 3 embodiment, a dual-tuner system may be employed and the second tuner may be embodied in a discrete component, providing the display system manufacturer a method to feature-scale the system with a second tuner option, and the second tuner may connect to the core video processing subsystem (203) through an auxiliary video interface (114).

In one embodiment, the video processing subsystem (203) may generally include de-interlacing technology to convert from interlaced data formatted inputs, such as provided by conventional NTSC/PAL/SECAM analog video, to a progressive scan type format. This may generally require large amounts of video frame memory, conventionally provided by an external DRAM memory IC device (204). The video processing subsystem (203) generally may include scaling algorithms to fit video images to the target display size, algorithms such as filters to smooth edges on video images, and color space conversion algorithms. In many cases, the video processing subsystem (203) may include methods of overlay more than one video source, called Picture On Picture (POP) and Picture In Picture (PIP), that scale the image specifically for the purpose of overlay or side-by-side display of multiple video sources. The video processing subsystem (203) may generally output a high-speed LVDS (low voltage differential signal) interface that multiplexes red, green, blue pixel color information to pass to the target display panel (206). Some state-of-the-art display processors may integrate the digital-to-analog D2A circuit to create the LVDS signal interface, and some may rely on external D2A circuits. The LVDS signal interface is utilized by convention for LCD display modules, plasma display modules, and other types such as the Texas Instrument's DLP (digital light processing) display module.

The display system (200) may comprise conventional primary audio inputs interface (202) for receiving audio from a variety of external audio sources such as AV analog audio inputs, tuner inputs, and PC audio inputs. In one embodiment, the audio processing sub-system (205) outputs at least a left and right channel of stereo audio to a sound system and may perform amplification, which drives the sound systems such as a speaker system (210) or a headphone jack (209).

Display systems conventionally implement a programmable system CPU (212), which in state-of-the art systems is generally either an 8-bit discrete processor, or 32-bit RISC processor, sometimes integrated to the video processing subsystem (203). The programmable system CPU (212) may interface to RAM and ROM memory, which may be integrated to the system CPU (212), and operates an instruction set to provide general system control algorithms, such as interfacing with a front input panel with buttons (207) for volume and channel control, receiving control through an infrared IR port (208), setting parameters of the display module, configuring system devices, etc. The programmable system CPU (212) may provide a graphical user interface capable of text-based overlay images or higher-resolution graphics to be displayed by connection with the video processing subsystem (203).

In one embodiment, a simple input/output host bus interface protocol (107), such as Philips I2C in one embodiment, may be used to communicate with other system devices. The I2C interface (107) can select the video input source from the primary video input system (201), and can select the audio source from the primary audio input system (202). In one embodiment, a CVBS (Composite Video Burst Signal) input to the system CPU (212) can provide programmable on-screen display (OSD), closed-caption, feature that can output data through an input/output interface connection to the video processing subsystem (203) for overlay with the desired video image. In some further embodiments, the OSD features are provided by a secondary CPU, or fixed-function component, called an OSD engine that passes data directly to the video processing subsystem (203). In one embodiment, video processing subsystem (203) integrates the OSD engine.

In one embodiment, the display connectivity controller (100) can be controlled by the core system programmable CPU (212) through the I2C interface (107) connection. The I2C control interface (107) can select the display connectivity controller (100) to enable the auxiliary video output (114) and/or the auxiliary audio output (119). Additionally, the system CPU (212) may execute instructions to control a DVC player (215) such as a camcorder, through the I2C bus (107) data exchange, whereas the data exchange initiates a set of 1394 transactions. In one embodiment, the 1394 transactions can be request packets transmitted from the display connectivity controller (100) followed by response packets transmitted from the DVC Player (215). These packets may be physically transmitted through the 1394 cable (214) that connects the DVC Player (215) to the first display system (200) through a 1394 port (122).

When the DVC Player (215) is attached to the system through cable (214) and port (122) method, the display connectivity controller (100) initiates a device discovery process to determine the capabilities of the 1394 device plugged into the port (122). In one embodiment, the device discovery process includes a set of 1394 bus transactions, whereas transactions are configuration ROM read requests from the display connectivity controller (100) and response packets transmitted by the DVC Player (215). The configuration data is compared to a pre-determined set of data, identifying the DVC Player (215) capabilities, and this match result is transmitted to the core system programmable CPU (212) over the I2C bus (107).

The display connectivity controller (100) is further capable to examine the isochronous data channels on the 1394 cable (214) to determine if DVC content can be received. The result of examining the isochronous data channels for DVC content is further communicated to the core system programmable CPU (212) over the I2C bus (107).

Additionally, the display connectivity controller (100) may optionally include a media card socket (213) for attachment of a media card (121) to display system (200). Control of the media card (121), including but not limited to power control of the media card (121), can be achieved by a connection to the core system programmable CPU (212) over the I2C bus (107). The implementation of this media card connectivity feature is illustrated in the previous description of the display connectivity controller (100) of FIG. 2.

Furthermore, it is understood by those skilled in the art that the frame buffer RAM (111) in the display connectivity controller (100) can also be implemented by external DRAM in the first display system (200).

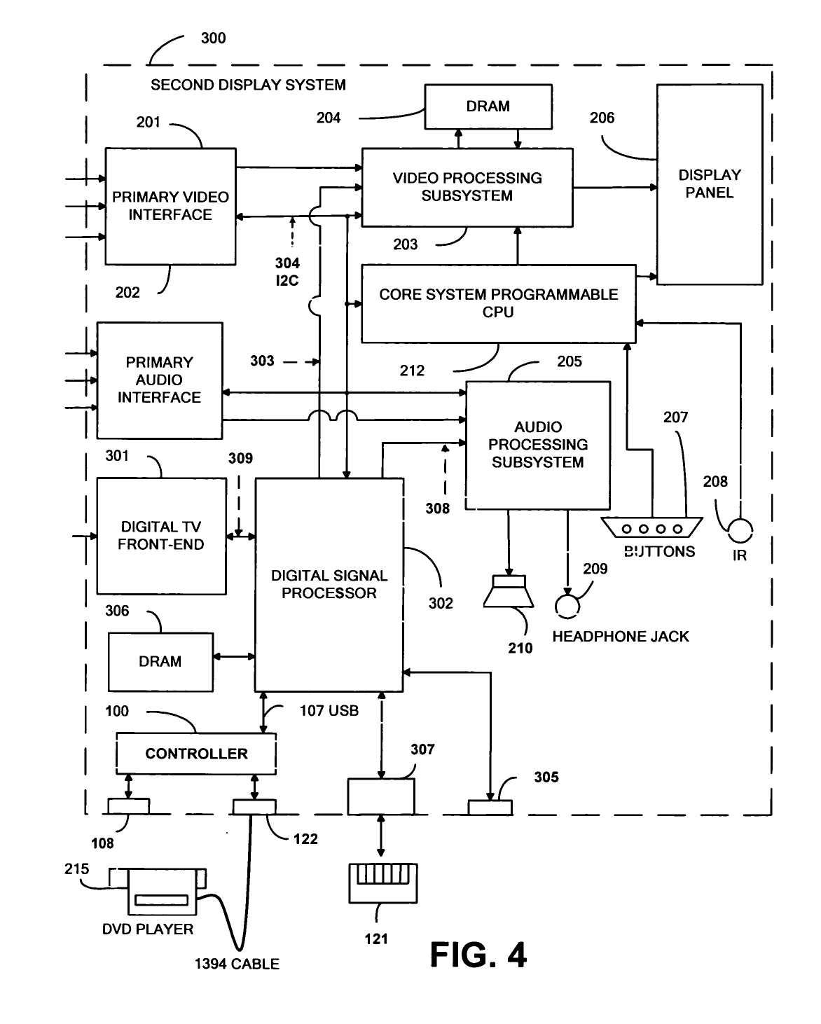

FIG. 4 illustrates a second enhanced display system (300) according to one embodiment of the present invention. The system comprises conventional primary video inputs (201), conventional primary audio inputs (202), audio processing subsystem (205), a video processing subsystem (203) with attached DRAM (204), display panel (206), a core system programmable CPU (212), IR (208) and buttons (207) for human interface control, a headphone jack (209) and speaker output (210). These aspects of FIG. 4 are identical to that described above and illustrated in FIG. 3.

A simple input/output host bus interface protocol (304), such as Philips I2C in one embodiment, is used to communicate between the core system programmable CPU (212) and other system devices. The I2C interface of the second enhanced display system (300) connects and controls a digital signal processor (302).

Equipped with a digital signal processor (302), the second enhanced display system (300) is capable of receiving digital TV broadcasts. The digital TV front-end circuits (301) include a TV tuner and demodulator subsystem for receiving RF signals for terrestrial television reception, whereas state-of-the-art tuners and demodulator systems support digital TV reception using standard protocols such as DVB-T, ATSC, and ARIB. The TV tuner and demodulator subsystem (301) for digital TV reception generally receives digital TV broadcasts based on the MPEG-2 compression algorithm, an MPEG-2 transport stream TS and data channel (309) can be delivered to a highly-integrated core digital TV processing subsystem (302) (i.e. the digital signal processor) for decoding to derive the audio/video outputs.

In one embodiment, the digital signal processor (302) may be equipped with video decoder circuitry used to convert MPEG-2 data received from the TS stream and data channel (309) to an auxiliary video output (303), and such output may be compatible with BT656. Additionally, the MPEG-2 TS stream and data channel (309) may provide encoded audio data to the digital signal processor (302), where audio decoding is performed to deliver an auxiliary audio output (308) to the audio processing subsystem (205), that may contain audio amplification circuits.

In addition to audio/video information, the connection between the digital TV front-end (301) and digital signal processor (302), the TS stream and data channel, may provide data packets based on the Internet protocol IP, such data may be useful to provide interactive television, whereas the display system is equipped with an internet connection (305), and IP addressing for data exchange between the system (300) and external IP capable devices may be based on IP addresses communicated in the TS stream and data channel (309).

The digital signal processor (302) may provide an enhanced graphical user interface for interactive TV support, including on-screen-display overlay images; whereas, there are significant advantages to integrate the digital signal processor to the video processing subsystem (203). One advantage is shared DRAM, such that dedicated DRAM (306) for the digital signal processor can be unified with the video processing subsystem DRAM (204).

In one embodiment, the MPEG-2 decoding function may be performed by an accelerator logic integrated into the digital signal processor, whereas the accelerator logic assists a high-end CPU that otherwise performs complex user interface tasks and data channel (309) processing. Such high-end CPU devices may generally provide connectivity to USB interface (107), and also may provide connectivity to a media card (121); whereas, the second display system (300) may provide a media card socket (307) independent of the media connectivity features of the connectivity controller (100).

In one embodiment, a CPU in the digital signal processor (302) may be further equipped to provide decode functions for various audio and video compression algorithms, including but not limited to MPEG-2, MPEG-4, M-JPEG, JPEG, MP3, AAC, and DVC. Connectivity to media content through the TS and data channel (309), USB (107), and media cards (121) may be preferred. In addition, the digital signal processor (302) may receive media content from the internet protocol connection (305).

In the second display system (300), the digital signal processor (302) may control the connectivity controller (100) by means of a USB connection (107). The USB connection (107) may be additionally used by the digital signal processor (302) to receive data packets containing DVC encoded video. The connectivity controller may receive DVC encoded video data from a DVC player (215) through a 1394 port connection (122) and the 1394 packets can be transmitted over a physical 1394 cable (214). The connectivity controller may create USB packets containing received DVC data, and transmits the USB packets over the USB connection (107) to the digital signal processor (302), where the DVC data is decoded into raw audio and video, whereas raw audio data in a digital format is transmitted to the audio processing subsystem (205) that may contain amplification circuitry. The raw video data in a digital format may be transmitted to the video processing subsystem (203) that will render the image with any user-requested PIP, POP, or GUI overlay for display to the display panel (206).

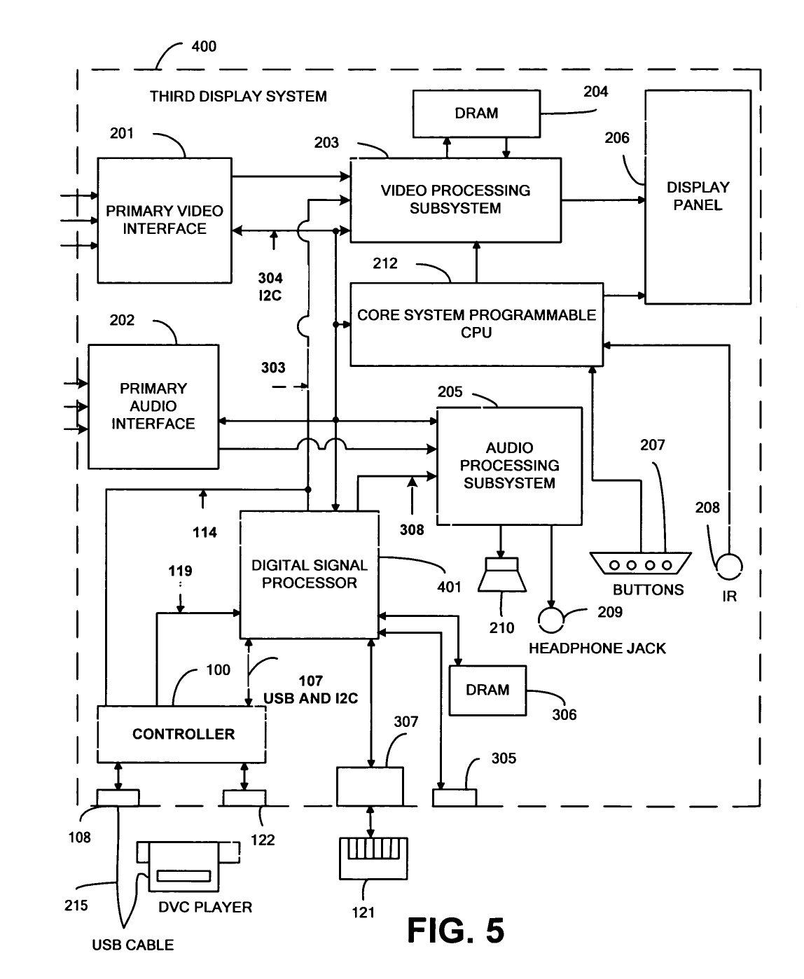

FIG. 5 illustrates a third enhanced display system (400) according to one embodiment of the present invention. Referring to FIG. 5 the system may comprise conventional primary video inputs (201), conventional primary audio inputs (202), audio processing subsystem (205), a video processing subsystem (203) with attached DRAM (204), display panel (206), a core system programmable CPU (212), IR (208) and buttons (207) for human interface control, a headphone jack (209) and speaker output (210). These features of the display system shown in FIG. 5 are identical to those of the display system described above and illustrated in FIG. 3.

The third display system (400) may also comprise an 12C connection (304) between the core system programmable CPU (212) and other system devices, including the digital signal processor (401). The digital TV tuner is not implemented in the FIG. 5, and the digital signal processor (401) may simply be used for connectivity to peripherals and internet protocol IP compatible external devices.

The digital signal processor (401) may be equipped with video decoder circuitry used to convert compressed video received through various connectivity methods to an auxiliary video output (303), such output may be compatible with BT656. Additionally, the digital signal processor may be equipped with audio decoder circuitry used to convert compressed audio received through various connectivity methods to an auxiliary audio output (308).

Similar to the second display system (300), the third display system (400) may be equipped with an internet connection (305), whereas the internet connection may be used to remotely control devices that use the internet protocol, and can accept IP packets for control, including control of streaming content that can be received by the display system (400). Such protocols such as Universal Plug and Play exist, and general guidelines published by the Digital Living Network Alliance (DLNA) exist, to accommodate such control. The software application for control may operate on a high-end CPU, and is generally referred to as a content distribution application. In one embodiment, the digital signal processor (401) of FIG. 5 can operate a content distribution application.

Similar to the digital signal processor of FIG. 4 (302), the digital signal processor of FIG. 5 (401) may be equipped with decode functions for various audio and video compression algorithms, including but not limited to MPEG-2, MPEG-4, M-JPEG, JPEG, MP3, AAC, and DVC. The digital signal processor (401) may preferably use an external DRAM (306) for frame buffer storage as well as packet buffer space and RAM workspace for the high-end CPU that performs several decode functions by means of instructions operating de-compression algorithms, and controlling data flow to accelerator logic integrated into the digital signal processor (401) to assist the decode functions.

Utilizing a high-end CPU as an integral component of the digital signal processor (401) is common between the second display system (300) and the third display system (400). In one embodiment, such a CPU device may provide connectivity to USB interface (107), and also may provide connectivity to a media card (121); whereas, the third display system (400) may provide a media card socket (307) independent of the media connectivity features of the connectivity controller (100).

In the third display system (400), the digital signal processor (401) may control the connectivity controller (100) by means of an I2C connection, whereas the host interface (107) to the connectivity controller (100) may comprise an I2C connection and a USB connection. The USB component of the host interface (107) may be used by the digital signal processor (401) to transmit data packets containing DVC encoded video, whereas the digital signal processor (401) may receive DVC encoded video data from a DVC player (402) through a USB port connection (108), whereas the USB packets are transmitted over a physical USB cable (403). There are some camcorders in the market that have the USB interface and the mini-DV cassette type data storage method, such camcorders are accommodated by the third display system (400).

The connectivity controller (100) may receive USB packets containing received DVC data, and perform the decoding of the DVC data into raw audio and video, whereas raw audio data in a digital format is transmitted to the digital signal processor (401) over an I2S auxiliary audio output (119), and raw video data in a digital format is transmitted to the video processing subsystem (203) by means of a BT656 auxiliary video output (114). Alternately, the connectivity controller can transmit the I2S auxiliary audio (119) to the audio processing subsystem (205). In system (400) of FIG. 5, the connectivity controller (100) comprises an alternate path to acquire DVC data, that is, through the 1394 port (122).

The BT656 auxiliary video output (114) is shared between the digital signal processor (401) and the connectivity controller (100), and only one device may drive the interface at the same time. When the connectivity controller (100) is not controlled to drive the BT656 interface (114), it will place the outputs in a high-impedance state. In the one embodiment, the choice of whether to use the DSP (401) or the connectivity controller (100) for driving the BT656 interface (114) is determined by an operation of the content distribution application operating on the digital signal processor (401), which controls the connectivity controller (100) by means of the I2C interface.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A display connectivity controller coupled externally to a display system, comprising:
a device detector for detecting the connectivity status of a digital video cassette (DVC) content source and acquiring capabilities data of said DVC content source;
a play control device for controlling playback modes of said digital video cassette content source;
a host bus interface for communicating with said display system; and
a host bus interface logic set for receiving commands from a processor of said display system through said host bus interface and communicating with said device detector and said play control device according to said commands.

2. The display connectivity controller of claim 1, wherein said host bus interface is an I2C interface.

3. The display connectivity controller of claim 1, wherein said host bus interface is a UART interface.

4. The display connectivity controller of claim 1, wherein said host bus interface is a USB interface.

5. The display connectivity controller of claim 1, further comprising:
a first signal interface for communicating with said DVC content source through a 1394 bus; and
a 1394 transaction layer logic set, wherein data exchanges between said host bus interface logic set and said DVC content source is accomplished by means of said 1394 transaction layer logic set.

6. The display connectivity controller of claim 1, further comprising a second signal interface communicating with said DVC content source through a USB bus.

7. The display connectivity controller of claim 1, further comprising a video decoder for generating a first video data by performing an inverse transform function to digital video cassette data acquired from said DVC content source.

8. The display connectivity controller of claim 7, further comprising a playback mode detect logic for detecting the playback mode of said DVC content source.

9. The display connectivity controller of claim 8, further comprising:
a fixed image logic set for generating pre-determined second video data;
a video output interface; and
a frame select logic set for switching between said first video data and said second video data based on the playback mode provided by said playback mode detect logic and causing transmission out over said video output interface.

10. The display connectivity controller of claim 9, wherein said video output interface is a BT656 interface.

11. The display connectivity controller of claim 9, wherein said video output interface is enabled by receiving said commands.

12. The display connectivity controller of claim 8, further comprising an on-screen display (OSD) logic for generating OSD video data to overwrite a pre-determined location of a video frame.

13. The display connectivity controller of claim 12, wherein said OSD video data represents an icon, said icon representing a connection status of said DVC content source based on said connectivity status.

14. The display connectivity controller of claim 12, wherein said OSD video data represents an icon and said icon represents said playback mode.

15. The display connectivity controller of claim 1, further comprising:
an audio processor for de-mixing the digital video cassette data acquired from said DVC content source; and
an audio output interface, wherein the de-mixed digital video cassette data is output through said audio output interface.

16. The display connectivity controller of claim 15, wherein said audio output interface is a Philips I2S interface.

17. The display connectivity controller of claim 9, further comprising:
a media card interface for communication with an exchangeable non-volatile media card; and
a media video decoder for generating a third video data, said third video data being generated by performing an inverse transform function to encoded video content acquired from said memory card.

18. The display connectivity controller of claim 17, wherein said second video decoder is a JPEG decoder.

19. The display connectivity controller of claim 17, wherein said second video decoder is an MPEG decoder.

20. The display connectivity controller of claim 17, further comprising:
an audio output interface for transmitting audio data;
a media card audio processor for generating a media audio source by performing logic operations on audio content acquired from said media card;
a DVC audio processor to generate a DVC audio source by performing logic operations on audio content acquired from said DVC content source; and
a multiplexing logic for selecting between said media audio source and said DVC audio source based on said commands, wherein selected audio source is transmitted out over said audio output interface.

21. A display system, comprising:
a video processing subsystem having an auxiliary video channel input and a primary video channel, said video processing subsystem being adapted to select between said auxiliary video channel and said primary video channel to a display output;
a programmable CPU in communication with the video processing subsystem for providing video sources for a graphical user interface;
a 1394 port for connecting a digital video cassette (DVC) content source;
a display connectivity controller coupled to said 1394 port, comprising:
a signal interface for communication with said 1394 port, a device detector for detecting said DVC content source and acquiring capabilities data of said DVC content source;
a video decoder for generating a first video data by performing an inverse transform function to data acquired from said DVC content source;
a fixed image logic for writing a pre-determined second video data;
a frame select logic set for selecting between said first video data and said second video data and generating a video output to said auxiliary video channel; and
an input/output interface for exchanging control data between said programmable CPU and said display connectivity controller, said control data being adapted to enable said video output.

22. The system of claim 21, wherein said auxiliary video channel input is a BT656 interface.

23. The system of claim 21, wherein said video processing subsystem selects a video channel based on an I2C interface signal.

24. The system of claim 21, wherein said input/output interface is an I2C interface.

25. The system of claim 21, wherein said input/output interface is a UART interface.

26. The system of claim 21, wherein said programmable CPU further comprises a human interface device (HID) interface, said HID interface receiving data that is used to control said video processing subsystem to select between said auxiliary video channel and said primary video channel.

27. The system of claim 21, wherein said display connectivity controller further comprises a media card interface.

28. The system of claim 21, wherein said display connectivity controller further comprises an I2S audio output.

29. A display system, comprising:
a digital signal processor, comprising:
a first signal interface for operating a first communication protocol to receive data packets, said data packets containing digital video cassette (DVC) encoded video;
a video decoder for decoding said DVC encoded video;
a 1394 port for connecting a digital video cassette (DVC) content source;
a display connectivity controller comprising:
a signal interface for communicating with said 1394 port,
a first logic set for receiving said DVC encoded video from said 1394 port;
a second logic set for providing said data packets containing DVC encoded video,
a third logic set for operating said first communication protocol to transmit said packets to said digital signal processor.

30. The system of claim 29, wherein said first signal interface is a USB interface.

31. The system of claim 29, wherein said display connectivity controller further comprises a media card interface.

32. The system of claim 31, wherein data exchange with said media card interface is controlled by said first signal interface.

33. The system of claim 29, wherein said digital signal processor further comprises a second signal interface for communicating with devices using Internet Protocol.

34. A display system, comprising:
a digital signal processor having a first signal interface for operating a first communication protocol to transmit data packets, said data packets containing digital video cassette (DVC) encoded video;
a USB port for connecting a digital video cassette (DVC) content source;
a display connectivity controller comprising:
a first logic set for receiving said DVC encoded video from said first signal interface;
a video decoder for decoding said DVC encoded video, video decoder being adapted to operate an inverse transform function and outputting to a video output.

35. The system of claim 34, wherein said first signal interface is a USB interface.

36. The system of claim 34, wherein said display connectivity controller further comprises a media card interface.

37. The system of claim 36, wherein data exchange with said media card interface is controlled by said first signal interface.

38. The system of claim 34, wherein said digital signal processor further comprises a second signal interface for communicating with devices using Internet Protocol.

39. The system of claim 34, wherein said display connectivity controller further comprises a second signal interface for receiving DVC encoded video.

40. The system of claim 39, wherein said second signal interface is a 1394 interface.

41. The system of claim 40, wherein said display connectivity controller further comprises 1394 bus management functions.

42. The system of claim 34, wherein said video output is a BT656 interface.

43. The system of claim 34, wherein said digital signal processor operates a content distribution application.

44. The system of claim 43, wherein said content distribution application conforms to DLNA Guidelines.
